(19) United States
(12) Patent Application Publication
(10) Pub. No.: US 2026/0336640 A1
(43) Pub. Date: Oct. 29, 2026

(54) METHOD FOR EVALUATING REDUNDANT SIGNALS

(71) Applicant: Robert Bosch GmbH, Stuttgart (DE)

(72) Inventor: Douglas Marques Fantini, nECKARATAILFINGEN (DE)

(21) Appl. No.: 19/117,903

(22) PCT Filed: Oct. 18, 2023
(86) PCT No.: PCT/EP2023/078952

§ 371 Date: Apr. 2, 2025

(30) Foreign Application Priority Data
Nov. 14, 2022 (DE) 10 2022 212 049.3

(51) Int. Cl. B60W 50/02

(52) U.S. Cl. CPC B60W 50/0205; B60W 2050/0215

(57) ABSTRACT

A method for evaluating redundant signals in a motor vehicle. A first signal is compared with a second signal, a result of the comparison is compared with a threshold value, wherein the threshold value is determined depending on a statistical analysis of the signals and depending on information on a driving situation of the motor vehicle.

### FIELD

The present invention relates to a method for evaluating redundant signals and to an arrangement for performing the method.

### BACKGROUND INFORMATION

In motor vehicles, a plurality of signals is sensed during operation, each signal carrying information on a technical variable. This information is evaluated in the motor vehicle. In order to ensure safe operation, it is necessary to check whether the sensed signals are correct or erroneous. One way to do so is by using or sensing redundant signals. This means that a technical variable is recorded multiple times, i.e., there are at least two signals representing this technical variable. By comparing the, in particular two, signals, they can then be checked for plausibility. Thus, errors that occurred when sensing and/or transmitting these signals can thus also be detected.

The method described here may be used, for example, in conjunction with an inertial measurement unit. The term “inertial measurement unit” is understood to mean a spatial arrangement of multiple inertial sensors, such as acceleration sensors and rotation rate sensors. Such a measurement unit is used, for example, as a sensory measurement unit of an inertial navigation system.

By means of an inertial measurement unit, six possible kinematic degrees of freedom can be sensed. To this end, three orthogonal acceleration sensors are used to sense the translational movements and three orthogonal rotation rate sensors are used to sense rotating or circular movements. In this case, the inertial measurement unit provides three linear acceleration values for the translational movements and three angular velocities or angular rates for the rotation rates as measured values.

If at least two signals are sensed for a variable, these signals are referred to as redundant signals. Concepts for handling these redundant signals in order, in particular, to check them for plausibility, i.e., to detect potentially erroneous signals, are referred to as redundancy concepts.

A redundancy concept that is currently used and implemented in inertial measurement units is referred to as a correlation monitor and is based on the comparison of measurements of the same physical variable, such as acceleration or angular rate, from different sources. For a given pair of redundant signals, two parameters are calculated, namely, delta and the gradient.

Delta is the difference between the current or present samples. The gradient is the difference between the signal rate of change, i.e., the discrete derivative. These parameters are calculated for each signal, using the current or present sample and the previous sample.

Once delta and the gradient have been calculated, they are compared with threshold values. If these threshold values are exceeded, a counter is incremented. The conditions for incrementing this counter can be combined in three ways. They are: delta only, gradient only, delta and gradient. If both conditions are used to increment the counter, they are connected or linked using a logical OR. This means that any condition that is met causes the counter to be incremented. If both conditions are met, however, the counter is incremented not twice but only once.

It is assumed that the signals correlate until the counter has reached a limit value. Once this limit value is reached, the counter value is set to a hold value that is higher than the limit value. A correlation flag is also set. This means that the signals are marked as uncorrelated. The counter value is held at the hold value as long as the conditions for incrementing are met. When these conditions are no longer met, the counter starts to decrement until the value zero is reached, and only then is the correlation flag removed or cleared. The signals are thus again marked as correlated.

This conventional flow is performed using the last measured values and the values immediately preceding them. In this sense, such a procedure is practically immediate. This comparison thus does not use any memory or involve any storing. However, this is currently provided for the correlation monitor in that counters are used to debounce the flags.

The settable parameters of this implementation for a redundant signal pair are listed below:
threshold value for delta,
threshold value for the gradient,
conditions for incrementing, delta only, gradient only, or both,
counter limit value,
counter hold value.

### SUMMARY

According to the present invention, a method and an arrangement are provided. Example embodiments of the present invention are disclosed herein.

The method according to the present invention may be used to evaluate redundant signals as they are sensed, for example, by means of an inertial measurement unit. However, the method is not limited to this embodiment.

One example embodiment of the method of the present invention is based on knowledge gained on the following challenges arising in the operation of an inertial measurement unit.

Currently, the redundancy monitoring concept demonstrates only low performance when tested with error introduction, wherein vehicle measurements from the test catalog are used. The conventional implementation has not yet been able to detect most of the errors that have been introduced into one of the redundant signals. This causes the signals to be uncorrelated. Additionally, in this case, potential customers will strive to reduce threshold values for the correlation.

In addition, it has been found that faults and threshold values are not representative. Not only the error types and their magnitudes but also the threshold values in the correlation monitor implementation were defined under the strong influence of the last generations of inertial measurement units, with the expectation that the signals are used in most cases in braking systems (ESP: electronic stability program). Inertial measurement units are focused on autonomous driving applications, making it necessary to reconsider the approach of error definition and threshold value definition.

Currently, the correlation monitor for inertial measurement units is a hardcoded static solution. This means that, as soon as the sensor is flashed, the redundancy monitoring parameters will remain virtually independent of the application. No setting corresponds to hardcoded. In addition, this property does not account for the vehicle dynamics in the current implementation. This means that the threshold values will also remain independent of the driving scenario. No adaptability thus means static. The inability to set the parameters and to adapt them to the environment is contrary to the current trends in the automotive sensor market, in particular in the case of autonomous driving applications.

The method presented according to the present invention is used to evaluate redundant signals in a motor vehicle. According to an example embodiment of the present invention, in the method, a first signal is compared with a second signal and a result of the comparison is compared with a threshold value. The threshold value is determined depending on a statistical analysis of the signals and depending on information on a driving situation of the motor vehicle.

The presented method of the present invention redefines the manner in which signal redundancy is monitored. For this purpose, faults relevant to autonomous driving scenarios can be considered together with vehicle dynamics and signal-to-noise properties. This is based on finding safety-critical decisions that are primarily made based on signals, for example the signals of an inertial measurement unit, and on defining the maximum permitted signal deviation. The current driving situation and the influence of noise on the integrated signals are taken into account.

In the approach presented according to an example embodiment of thee present invention, a similar procedure is applied in embodiments to the acceleration signals and angular rate signals within a typical autonomous vehicle architecture. First, a random or stochastic random walk, namely, angle or position, is estimated depending on the signal. Then, this estimate is integrated into the formulation of the maximum permitted signal deviation. Finally, the measured signal deviation is compared with the defined threshold value. The resulting information is converted into a flag.

At different locations in the flow, external parameters are used for the calculations, making it possible for the OEM (original equipment manufacturer) to design the characteristic of the target vehicle and to adapt it to the particular driving situation. Additionally, the signal properties are estimated, using previous samples to evaluate the quality of the estimates dynamically.

An example embodiment of the method of the present invention is discussed below:

### Random Walk

The first step is to define the error caused by the integration of the noise signals. For the angular rate signals, only one integration step is required to obtain the angle random walk. For the acceleration signals, it is necessary to perform the integration twice in order to obtain the position random walk. In both cases, the input parameters for the calculation are the integration time, the noise properties of the original signal, and the signal sampling frequency. In this respect, reference is made to FIGS. 1 and 2. This step takes into account only the noise in the signals in order to estimate the random walk. By varying the parameters, it is possible to define a characteristic surface, see FIGS. 3 and 4.

### Accelerator Signal Deviation

By using the longitudinal control, i.e., by accelerator pedal and brake, as a reference, the scenario taken into account assumes that the vehicle is traveling on a straight road and must suddenly carry out emergency braking, wherein coupled navigation is used. The goal is to stop the vehicle within a predefined longitudinal safety limit. This is not possible in this case. The vehicle should either perform an emergency evasive maneuver or trigger damage mitigation systems.

After mathematically converting the equations for a linear movement and a discrete integration, together with some worst-case assumptions, the maximum permitted deviation is expressed by the following equation:

Δₘₐₓ=Sₗᵢₘ·Aₗₒₙ//2·dt·V₀ (1)

Here, V₀ is the initial longitudinal velocity of the vehicle, Aₗₒₙ is the expected longitudinal deceleration during braking, Sₗᵢₘ is the longitudinal safety limit, and dt is the signal sampling time, see FIG. 5.

### Angular Rate Signal Deviation

By using the lateral control, i.e., by steering, as a reference, the scenario considered assumes that the vehicle is traveling on a curvy road and needs to stay in the lane, wherein coupled navigation is used. The goal is to keep the vehicle within a predefined lateral safety limit. This is not possible in this case. The vehicle should either trigger decoupling or carry out emergency braking.

After mathematically converting the equations for a circular movement and a discrete integration, together with some worst-case assumptions, the maximum permitted deviation is expressed by the following equation.

$${Δ}_{max} = {cos}^{- 1} ( 1 - \frac{{( \frac{{S}_{lim}}{{T}_{dr} \cdot {V}_{lon}} )}^{2}}{2} ) / dt \qquad ( 2 )$$

Here, Vₗₒₙ is the longitudinal velocity of the vehicle, T_{dr} is the coupling time, Sₗᵢₘ is the lateral safety limit, and dt is the signal sampling time, see FIG. 6.

### Debouncing and Final Flag Arrangement

The final step in this example embodiment of the method of the present invention is to estimate the estimated values of the random walk with the threshold formulation and to compare the latter with the measured signal deviation. The implementations for acceleration and angular rate differ slightly, but the strategy is the same. It is necessary to debounce this comparison before converting the result into a correlation flag, see FIGS. 7 and 8.

If necessary, some parameters described for this method may be hardcoded. However, the idea is to have a generic description that can be adapted to any specific case.

The described arrangement is configured to perform the method presented here and may, for example, be implemented in hardware and/or software. Furthermore, the arrangement may also be integrated in or designed as a control unit of a vehicle.

Further advantages and embodiments of the present invention emerge from the description and the figures.

It is understood that the aforementioned features and the features yet to be explained below can be used not only in the specified combination but also in other combinations or on their own, without leaving the scope of the present invention.

### BRIEF DESCRIPTION OF THE DRAWINGS

FIG. 1 shows the calculation of the position random walk in a chart.

FIG. 2 shows the calculation of the angle random walk in a chart.

FIG. 3 shows a position random walk estimation surface in a graph.

FIG. 4 shows an angle random walk estimation surface in a graph.

FIG. 5 shows the maximum deviation for acceleration signals in a graph.

FIG. 6 shows the maximum deviation for angular rate signals in a graph.

FIG. 7 shows an example embodiment of the presented method in a flow chart.

FIG. 8 shows a further example embodiment of presented method in a flow chart.

### DETAILED DESCRIPTION OF EXAMPLE EMBODIMENTS

The present invention is illustrated schematically in the figures on the basis of example embodiments and is described in detail below with reference to the figures.

The method is described below in conjunction with an inertial measurement unit but is not limited to this embodiment; rather, it can be used anywhere in the motor vehicle, in particular where redundant signals are to be evaluated.

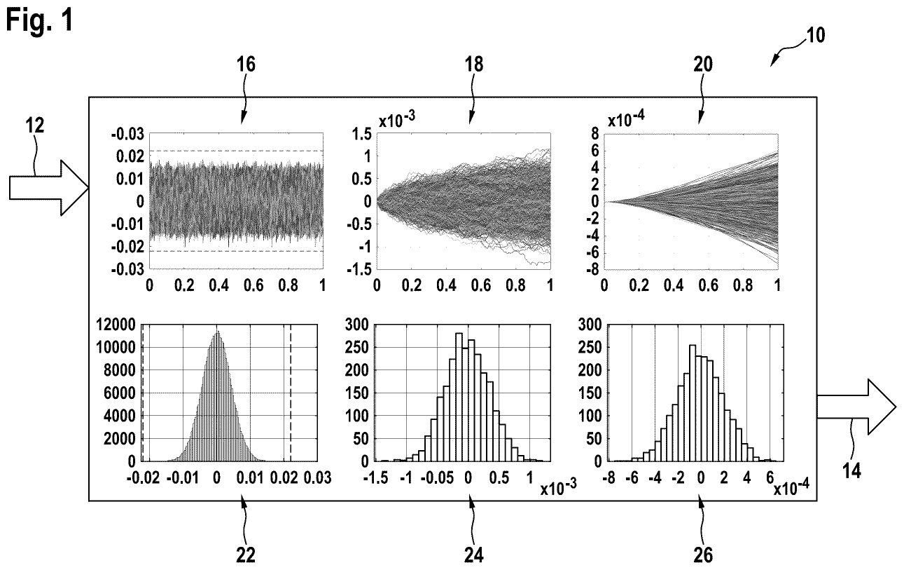

FIG. 1 illustrates the calculation of the position random walk in a graph 10. In this respect, it should be noted:

The motor vehicle uses the inertial measurement unit for the coupled navigation for T_{dr} seconds, and the only difference between the redundant signals is given by the noise parameters. The noise in the redundant signals is integrated twice. The standard deviation for the resulting position, the linear random walk, is found as a function of the noise properties in Aₗₒₙ, i.e., σ_{A} and σ_{B} in the redundant signals, T_{dr}, and the signal sampling time dt.

Input variables 12 are the integration time T_{dr}, the sampling frequency 1/dt, and the noise of the acceleration sensor σ_{Acc}. Output variable 14 is the position random walk σ_{Pos}. A first graph 16 shows acceleration curves, a second graph 18 shows velocity curves, a third graph 20 shows positions, a fourth graph 22 shows a histogram of noise, a fifth graph 24 shows a histogram of endpoints, and a sixth graph 26 also shows a histogram of endpoints.

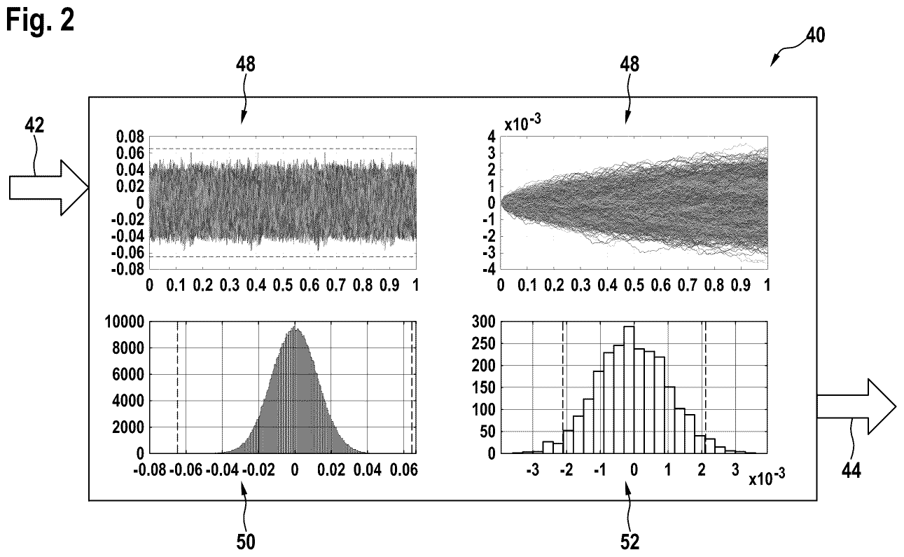

FIG. 2 illustrates the calculation of the angle random walk in a graph 40. In this respect, it should be noted:

The motor vehicle uses the inertial measurement unit for the coupled navigation for T_{dr} seconds, and the only difference between the redundant signals is given by the noise parameters. The noise in the redundant signals is integrated once. The standard deviation for the resulting position, the angle random walk, is found as a function of the noise properties in the yaw rate, i.e., σ_{A} and σ_{B} in the redundant signals, T_{dr}, and the signal sampling time dt.

Input variables 42 are the integration time T_{dr}, the sampling frequency 1/dt, and the rate noise σ_{Rate}. Output variable 44 is the angle random walk σ_{Ang}. A first graph 46 shows the angular rate, a second graph 48 shows angles, a third graph 50 shows a histogram of noise, and a fourth graph 52 shows a histogram of endpoints.

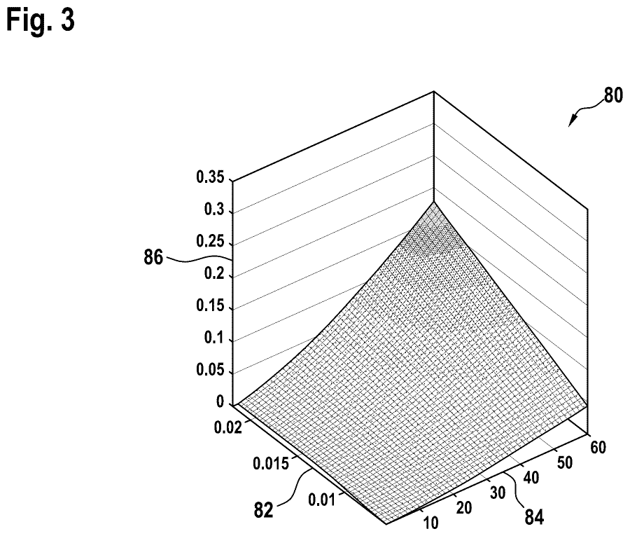

FIG. 3 shows a position random walk estimation surface at a sampling rate of 1000 Hz in a graph 80, with the signal noise plotted on one abscissa 82, the integration time plotted on the other abscissa 84, and the position random walk plotted on the ordinate 86.

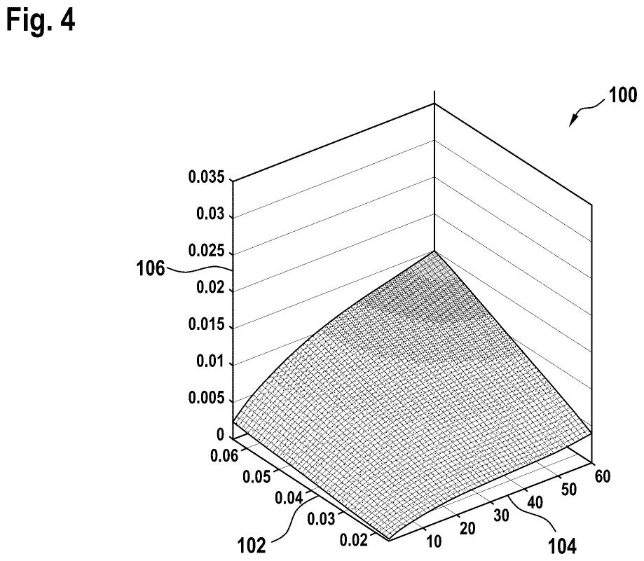

FIG. 4 shows an angle random walk estimation surface at a sampling rate of 1000 Hz in a graph 100, with the signal noise plotted on one abscissa 102, the integration time plotted on the other abscissa 104, and the angle random walk plotted on the ordinate 106.

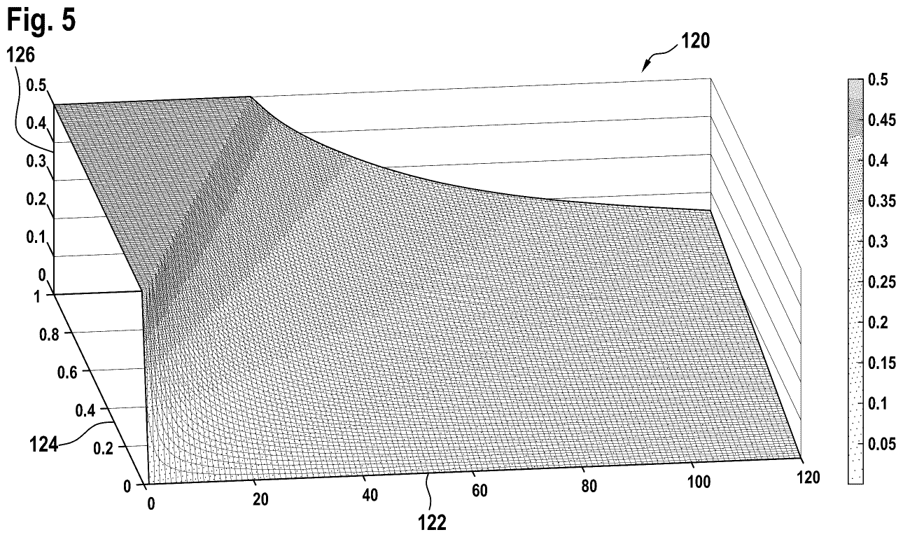

FIG. 5 shows a surface of the maximum deviation for acceleration signals in a graph 120, with the initial vehicle velocity plotted on one abscissa 122, the expected maximum deviation plotted on the other abscissa 124, and the maximum permitted deviation plotted on the ordinate 126.

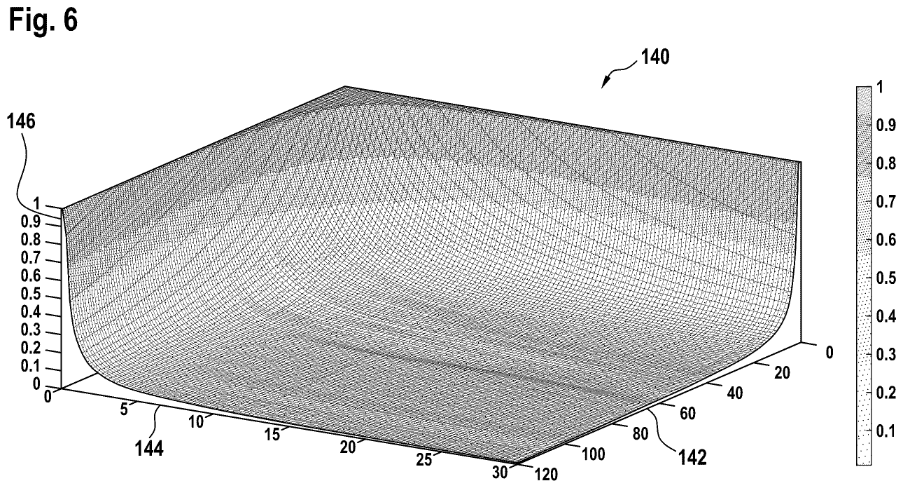

FIG. 6 shows a surface of the maximum deviation for angular rate signals in a graph 140, with the initial vehicle velocity plotted on one abscissa 142, the integration time plotted on the other abscissa 144, and the maximum permitted deviation plotted on the ordinate 146.

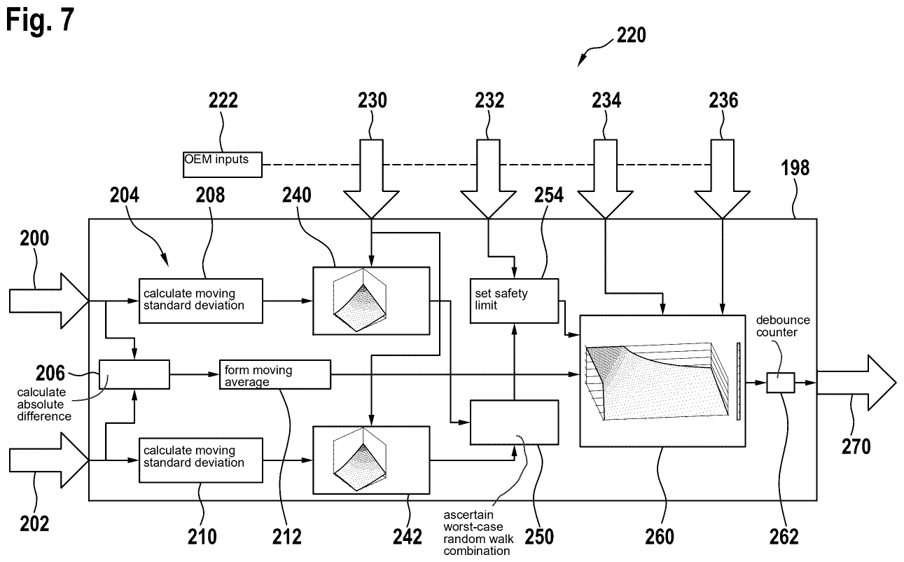

FIG. 7 shows a possible flow of the presented method in a flow chart and schematically illustrates the implementation of redundancy monitoring for acceleration signals in an arrangement 198 for performing the method.

Input variables are an acceleration signal (dt) A 200 and an acceleration signal (dt) B 202. First, a statistical analysis 204 takes place, which comprises calculating an absolute difference (delta) in a step 206, calculating a moving standard deviation on the basis of N previous samples of the input variable A 200 in a step 208, calculating a moving standard deviation on the basis of N previous samples of the input variable B 202 in a step 210, and forming a moving average on the basis of the N previous samples in a step 212.

Furthermore, OEM inputs 222 for the driving situation 220 are taken into account, namely, an integration time T_{dr} 230, a safety limit Sₗᵢₘ 232, a maximum expected deceleration Aₗₒₙ 234, and a vehicle velocity V₀ 236.

Taking into account the integration time T_{dr} 230 and the moving standard deviation 208, a first expected random walk 240 results. Taking into account the integration time T_{dr} 230 and the moving standard deviation 210, a second expected random walk 242 results. In a step 250, a worst-case random walk combination is ascertained from the two random walks 240 and 242. Then, taking into account the specified safety limit Sₗᵢₘ 232, a safety limit is set in a step 254 so that it includes the random walk.

Taking into account the maximum expected deceleration Aₗₒₙ and the vehicle velocity V₀, the maximum permitted deviation Amax is then ascertained with equation (1) in a step 260. In a step 262, the counter is then debounced to about 4. Finally, a correlation monitoring status 270 is output.

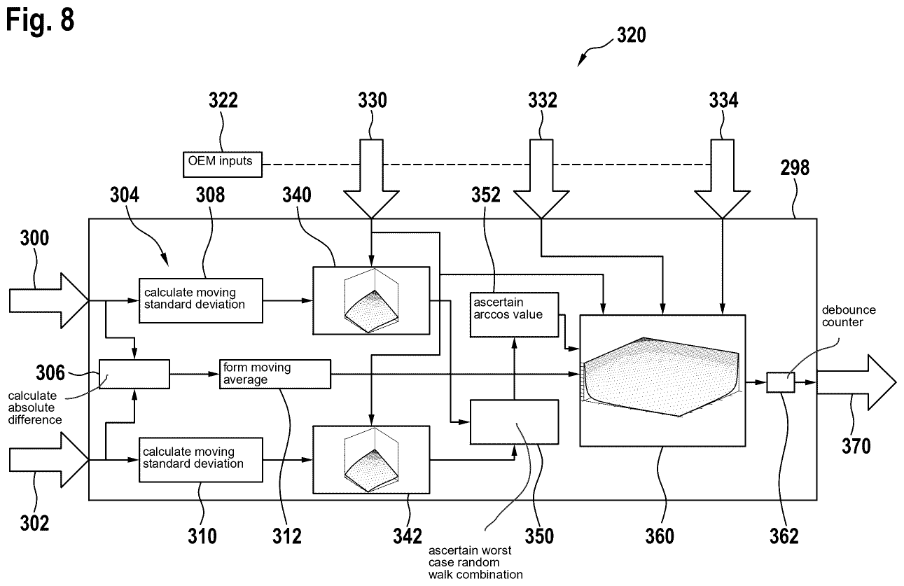

FIG. 8 shows a possible flow of the presented method in a flow chart and schematically illustrates the implementation of redundancy monitoring for angular rate signals in an arrangement 298 for performing the method.

Input variables are an acceleration signal (dt) A 300 and an acceleration signal (dt) B 302. First, a statistical analysis 304 takes place, which comprises calculating an absolute difference (delta) in a step 306, calculating a moving standard deviation on the basis of N previous samples of the input variable A 300 in a step 308, calculating a moving standard deviation on the basis of N previous samples of the input variable B 302 in a step 310, and forming a moving average on the basis of the N previous samples in a step 312.

Furthermore, OEM inputs 322 for the driving situation 320 are taken into account, namely, an integration time T_{dr} 330, a vehicle velocity Vₗₒₙ 332, and a safety limit Sₗᵢₘ 334.

Taking into account the integration time T_{dr} 330 and the moving standard deviation 308, a first expected random walk 340 results. Taking into account the integration time T_{dr} 330 and the moving standard deviation 310, a second expected random walk 342 results. In a step 350, a worst-case random walk combination is ascertained from the two random walks 340 and 342. Then, in a step 352, an arccos value is ascertained so that it includes the random walk.

Taking into account the vehicle velocity Vₗₒₙ and the safety limit Sₗᵢₘ 334, the maximum permitted deviation Amax is then ascertained with equation (2) in a step 360. In a step 362, the counter is then debounced to about 4. Finally, a correlation monitoring status 370 is output.

1-12. (canceled)

13. A method for evaluating redundant signals in a motor vehicle, comprising the following steps:
comparing a first signal is compared with a second signal; and
comparing a result of the comparison with a threshold value;
wherein the threshold value is determined depending on a statistical analysis of the first and second signals and depending on information on a driving situation of the motor vehicle.

14. The method according to claim 13, wherein a random walk is first ascertained within a framework of the statistical analysis, taking into account an integration of the first and second signals over time.

15. The method according to claim 13, wherein the statistical analysis includes at least one calculation step selected from a group including: calculating an absolute difference, calculating a moving standard deviation, calculating a moving average.

16. The method according to claim 13, wherein the information on the driving situation is selected from a group including: integration time, vehicle velocity, safety limit, maximum expected deceleration.

17. The method according to claim 13, wherein the method is carried out in conjunction with an inertial measurement unit.

18. The method according to claim 17, wherein signals from at least one acceleration sensor are evaluated.

19. The method according to claim 17, wherein signals from at least one rotation rate sensor are evaluated.

20. The method according to claim 13, wherein the method is used in an autonomously operated vehicle, wherein faults relevant to autonomous driving scenarios are taken into account.

21. The method according to claim 13, wherein a counter is incremented when the threshold value is exceeded.

22. The method according to claim 21, wherein the counter is decremented when the result of the comparison falls below threshold value.

23. An arrangement for evaluating redundant signals in a motor vehicle, wherein the arrangement is configured to:
compare a first signal is compared with a second signal; and
compare a result of the comparison with a threshold value;
wherein the threshold value is determined depending on a statistical analysis of the first and second signals and depending on information on a driving situation of the motor vehicle.

24. The arrangement according to claim 23, wherein the arrangement is configured for use in conjunction with an inertial measurement unit.
